(19) United States
(12) Patent Application Publication
(10) Pub. No.: US 2025/0133528 A1
(43) Pub. Date: Apr. 24, 2025

(54) METHODS AND APPARATUSES FOR CONFIGURING A RANGING PERIOD FOR A UE IN CELLULAR NETWORKS

(71) Applicant: Lenovo (Beijing) Limited, Beijing (CN)

(72) Inventors: Min Xu, Beijing (CN); Jing Han, Beijing (CN); Haiming Wang, Beijing (CN); Jie Hu, Beijing (CN)

(73) Assignee: Lenovo (Beijing) Limited, Beijing (CN)

(21) Appl. No.: 18/687,462

(22) PCT Filed: Sep. 3, 2021
(86) PCT No.: PCT/CN2021/116413

§ 371 Date: Feb. 28, 2024

(51) Int. Cl. H04W 64/00; H04L 5/00; H04W 36/08; H04W 92/18

(52) U.S. Cl. CPC H04W 64/00; H04L 5/0051; H04W 36/08; H04W 92/18

(57) ABSTRACT

Embodiments of the present application relate to methods and apparatuses for configuring a ranging period for a user equipment (UE) in a wireless network under a 3rd Generation Partnership Project (3GPP) 5G system or the like. According to an embodiment of the present application, a network node includes a processor and a wireless transceiver coupled to the processor; and the processor is configured to transmit, via the wireless transceiver to a UE, configuration information regarding a time period related to a ranging measurement operation between the UE and one or more further UEs, wherein the time period includes at least one of a ranging time window and a ranging time gap, wherein the ranging measurement operation is executed by the UE to the one or more further UEs during the ranging time window, and wherein a radio frequency (RF) switch procedure for the ranging measurement operation is executed by the UE during the ranging time gap.

### TECHNICAL FIELD

Embodiments of the present application generally relate to wireless communication technology, especially to methods and apparatuses for configuring a ranging period for a user equipment (UE) in cellular networks.

### BACKGROUND

Generally, “ranging” refers to determining a distance between two User Equipment (UEs) and/or a direction of one UE from another UE via a direct communication connection (e.g., as shown in FIG. 1), and the results can be used to emerge ranging-based services, e.g., a UE's discovery for video sharing between friends. Typically, “ranging” does not require the network to deploy positioning infrastructures or provide positioning services, as it is directly done between two or more UEs involved. Ranging between UEs can be implemented by transmission and reception of specific ranging reference signal including positioning reference signal (PRS) over a sidelink, and target-unaware ranging signal reflection including lasering. Ranging-based services are different from positioning services which can be sensitive due to privacy or regulation concerns.

Ranging-based services are becoming popular in a variety of verticals, such as, consumer, smart home, smart city, smart transportation, and industry. 3rd Generation Partnership Project (3GPP) initiated a Rel-18 Study Item “Study on Ranging-based Services” in June 2020 aiming to identify use cases and potential requirements of ranging-based services directly between two or more UEs.

In a 3GPP 5G system or network, however, details regarding configuring a ranging period for a UE in cellular networks have not been discussed in 3GPP 5G technology yet.

### SUMMARY

Some embodiments of the present application also provide a network node. The network node includes a processor and a wireless transceiver coupled to the processor. The processor is configured to transmit, via the wireless transceiver to a user equipment (UE), configuration information regarding a time period related to a ranging measurement operation between the UE and one or more further UEs, wherein the time period includes at least one of a ranging time window and a ranging time gap, wherein the ranging measurement operation is executed by the UE to the one or more further UEs during the ranging time window, and wherein a radio frequency (RF) switch procedure for the ranging measurement operation is executed by the UE during the ranging time gap.

Some embodiments of the present application provide a method performed by a network node. The method includes: transmitting, to a UE, configuration information regarding a time period related to a ranging measurement operation between the UE and one or more further UEs, wherein the time period includes at least one of a ranging time window and a ranging time gap, wherein the ranging measurement operation is executed by the UE to the one or more further UEs during the ranging time window, and wherein a RF switch procedure for the ranging measurement operation is executed by the UE during the ranging time gap.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a network node.

Some embodiments of the present application also provide a UE. The UE includes a processor and a wireless transceiver coupled to the processor. The processor is configured to receive, via the wireless transceiver from a network node, configuration information regarding a time period related to a ranging measurement operation between the UE and one or more further UEs, wherein the time period includes at least one of a ranging time window and a ranging time gap, wherein the ranging measurement operation is executed by the UE to the one or more further UEs during the ranging time window, and wherein a RF switch procedure for the ranging measurement operation is executed by the UE during the ranging time gap.

Some embodiments of the present application provide a method performed by a UE. The method includes: receiving, from a network node, configuration information regarding a time period related to a ranging measurement operation between the UE and one or more further UEs, wherein the time period includes at least one of a ranging time window and a ranging time gap, wherein the ranging measurement operation is executed by the UE to the one or more further UEs during the ranging time window, and wherein a RF switch procedure for the ranging measurement operation is executed by the UE during the ranging time gap.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary schematic diagram of ranging in a celestial coordinate in accordance with some embodiments of the present application;

FIG. 2 illustrates an exemplary diagram of ranging window(s) and ranging gap(s) for ranging implemented via ranging reference signal(s) in accordance with some embodiments of the present application;

FIG. 3 illustrates an exemplary flowchart of transmitting ranging opportunity configuration information in accordance with some embodiments of the present application; and

FIG. 4 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architectures and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

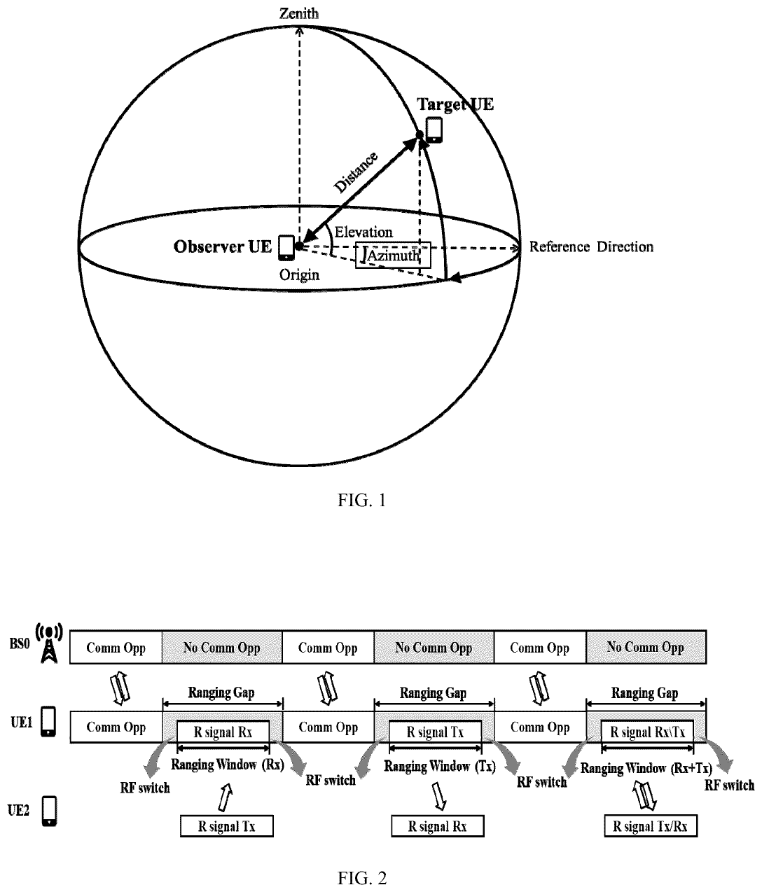

FIG. 1 illustrates an exemplary schematic diagram of ranging in a celestial coordinate in accordance with some embodiments of the present application.

In particular, the embodiments of FIG. 1 show “Observer UE” and “Target UE”. The Observer UE is located in “Origin” during a ranging operation in a celestial coordinate. “Distance” is a distance between the Observer UE and the Target UE. As shown in FIG. 1, “Reference Direction” is a default direction used by the Observer UE as reference for ranging the Target UE. Typically, the Reference Direction is the direction where the Observer UE pointing at with its top side. “Zenith” is the direction orthogonal to the same plane as the Reference Direction. As shown in FIG. 1, “Azimuth” (the horizontal direction) of the Target UE is the angle formed between the Reference Direction and a line from the Observer UE to the Target UE projected on the same plane as the Reference Direction orthogonal to the Zenith. “Elevation” (the elevation direction) of the Target UE is the angle above the same plane as the Reference Direction. When the ranging is implemented by transmission and reception of PRS over a sidelink, either the observer UE or the target UE can be considered as an anchor UE, e.g., depending on whether it is in or out of network coverage, or whether it is assistant in the ranging-based service.

In some embodiments of the present application, the UE in FIG. 1 (e.g., Observer UE and/or Target UE) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE in FIG. 1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE in FIG. 1 may include wearable devices, such as smart watches, fitness bands, optical head-mounted displays, or the like. Moreover, the UE in FIG. 1 may be referred to as a subscriber unit, a mobile, a mobile station, a user, a terminal, a mobile terminal, a wireless terminal, a fixed terminal, a subscriber station, a user terminal, or a device, or described using other terminology used in the art.

The legacy mechanisms in 3GPP LTE and NR have provided general principles of window and gap configuration for different measurements. In the legacy mechanisms, a source to be measured is a network node (e.g., for a synchronization signal block (SSB) measurement timing configuration (SMTC) measurement, a system frame number (SFN) and frame boundary timing difference (SFTD) measurement, and a reference signal time difference (RSTD) measurement) or the UE itself (e.g., for an in-device coexistence (IDC) measurement). As a result, the information of when the measurement window and corresponding gap are needed is known to the network or the UE. For ranging, a source to be measured is a target UE, and such information could be unknown to the network or to the observer UE. In this case, additional information exchange is needed before the configuration, including the type of configuration, the target UE's identifier (ID), relative capabilities of the observer UE, and/or relative capabilities of the target UE as proposed in the embodiments of the present application. Moreover, some additional mechanisms may be needed, e.g., to allow the network to find the target/observer UE for an observer/target UE in or out of its coverage.

In legacy mechanisms, only a UE that performs a measurement needs to be configured with a measurement window and/or a measurement gap, i.e., the measurement window and/or gap are only for reception. For ranging, both a source to be measured (e.g., a target UE) and a termination to perform measurement (e.g., an observer UE) need such configuration. In this case, the configured window and/or gap for ranging can be target-specific and with different purposes for reception and/or for transmission, and whether the gap is necessary may depend on a specific UE's capabilities and a purpose of the gap. The network needs to configure ranging windows or gaps aligning with both observer and target UEs.

Currently, a 3GPP system is considering support of ranging services for a UE with a wireless network access, e.g., smart phones or internet of things (IoT) devices with 4G/5G mobile network modules. An immediate issue is to determine a ranging opportunity (e.g., exact timing to perform ranging as an observer UE or transmit ranging reference signal as a target UE) for such UE. For a UE in any state (CONNECTED, IDLE or INACTIVE), the network can configure ranging window(s) in which it will not schedule communication so that the UE can process ranging services, considering that the UE may not be capable of performing a transmission and reception (i.e., full-duplex) or performing the transmission or the reception on different frequency bands (i.e., multiple RF modules activation) at the same time. More specifically, for a ranging operation implemented via a ranging reference signal, following four cases need to be considered. These four cases need ranging window(s) to process ranging services.
(1) For a UE in IDLE or INACTIVE mode as an observer UE, the UE may not be able to receive a ranging reference signal when the UE is receiving system information or paging from the network unless the UE supports multiple RF modules activation at the same time.
(2) For a UE in IDLE or INACTIVE mode as a target UE, the UE may not be able to transmit a ranging reference signal when the UE is receiving system information or paging from the network unless the UE supports full-duplex communication and multiple RF modules activation at the same time.
(3) For a UE in CONNECTED mode as an observer, the UE may not be able to receive a ranging reference signal when the UE is transmitting/receiving data or signaling to/from the network unless the UE supports full-duplex communication and multiple RF modules activation at the same time.
(4) For a UE in CONNECTED mode as a target UE, the UE may not be able to transmit a ranging reference signal when the UE is receiving/transmitting data or signaling from/to the network unless the UE supports full-duplex communication and multiple RF modules activation at the same time.

Currently, typical UEs in a 3GPP system only support a half-duplex communication and RF module activation at the same time (e.g., a UE needs a RF switch procedure to perform an inter-frequency measurement or use a global navigation satellite system (GNSS)). Following two issues need further considerations and solutions:
(1) Issue #1: How to configure ranging window(s) for a UE to avoid overlapping with legacy communication opportunities (system information window, paging window, cell measurement, data transmission or reception).
(2) Issue #2: How to configure ranging gap(s) for a UE to perform a RF switch procedure for ranging services.

To solve the abovementioned issues, embodiments of the present application provide details regarding ranging opportunity configuration for a UE in cellular networks. In some embodiments of the present application, to ensure aligned understanding at UE(s) and a network node for the timing of ranging between UE(s) and the cellular data exchange between the UE(s) and the network node, UE(s) intended to perform ranging may send a request in advance to the network node providing its assistance information and preference for ranging opportunity configuration, so that the network node can configure a ranging opportunity appropriately in response to avoiding possible disturbing between ranging and cellular data exchange, and provide, to UE(s), switch time between RF modules.

In some embodiments of the present application, except for regular parameters of a length, a repetition period, and start time that determine a time window, some ranging-specific elements are designed for the ranging opportunity request and configuration, e.g., including a type of a ranging window or gap (transmission and/or reception), a role of a UE (an observer UE, a target UE, and/or an anchor UE), associated UE IDs and preconditions of the UE's capability that indicate the applicability of configured ranging opportunity. Some embodiments of the present application design the ranging gap configuration for RF switching, considering both dedicated and shared configurations. Some embodiments of the present application provide additional mechanisms to allow the network to find a target/observer UE for an observer/target UE in or out of its coverage, and to provide with aligned or paired configuration.

Generally, ranging opportunity configuration for a UE with a network access can be applied in many scenarios. For instance, some embodiments of the present application are applied in Unmanned Aerial Vehicle (UAV) swarm communications. Considering a UAV swarm consisting of multiple UAV UEs with 4G/5G network access, ranging opportunity configuration can be used for:
(1) A UE's discovery during communication(s). The network or a master UAV in the swarm can configure a ranging opportunity to member UAVs. As a result, during such spare time of swarm communication between master UAV and member UAVs, a UAV can perform ranging on another UE(s) out of the swarm to find other candidate or backup UAVs to join the swarm, or to find other airborne UEs for conflict avoidance, or to find geo fencing devices for no-fly management.
(2) Formation maintenance during communication. The network or a master UAV in the swarm can configure ranging opportunity to member UAVs. As a result, during such spare time of swarm communication between master UAV and member UAVs, a UAV can perform ranging on other UAVs in the swarm to maintain the swarm formation.

In the embodiments of the present application, a ranging opportunity may also be named as “a ranging opportunity in time domain”, “a ranging time opportunity”, “a ranging period in time domain”, “a ranging time period”, or the like. In the embodiments of the present application, “a ranging window” and “a ranging gap” can be collectively referred to as “a ranging opportunity”. A ranging window may also be named as “a ranging window in time domain”, “a ranging time window”, or the like. A ranging gap may also be named as “a ranging gap in time domain”, “a ranging time gap”, or the like. More details will be illustrated in following text in combination with the appended drawings.

FIG. 2 illustrates an exemplary diagram of ranging window(s) and ranging gap(s) for ranging implemented via ranging reference signal(s) in accordance with some embodiments of the present application.

As shown in FIG. 2, “Comm Opp” indicates a common opportunity in time domain. “No Comm Opp” indicates a non-common opportunity in time domain. “R signal Rx” indicates a ranging reference signal reception. “R signal Tx” indicates a ranging reference signal transmission. “RF switch” indicates a RF switch procedure. In the embodiments of FIG. 2, for BS0 or UE1, there are multiple common opportunities and non-common opportunities in time domain. BS0 and UE1 may communicate with each other in each common opportunity as shown in double sided arrows of FIG. 2. Each of UE1 and UE2 may be Observer UE and/or Target UE as shown and illustrated in FIG. 1.

The embodiments of FIG. 2 design a ranging gap during each non-common opportunity of UE1 (i.e., “Ranging Gap” as shown in FIG. 2), and design a ranging window located within the ranging gap (i.e., “Ranging Window” as shown in FIG. 2). In time duration since “start time of the ranging gap” until “start time of the ranging window”, UE1 may perform a RF switch procedure. In time duration since “end time of the ranging window” until “end time of the ranging gap”, UE1 may perform a RF switch procedure. In time duration since “start time of the ranging window” until “end time of the ranging window”, UE1 may perform a ranging reference signal transmission and/or a ranging reference signal reception.

For instance, “Ranging Window (Rx)” indicates that UE1 performs a ranging reference signal reception while UE2 performs a ranging reference signal transmission during such ranging window. “Ranging Window (Tx)” indicates that UE1 performs a ranging reference signal transmission while UE2 performs a ranging reference signal reception during such ranging window. “Ranging Window (Rx+Tx)” indicates that UE1 performs both ranging reference signal transmission and reception with UE2 during such ranging window.

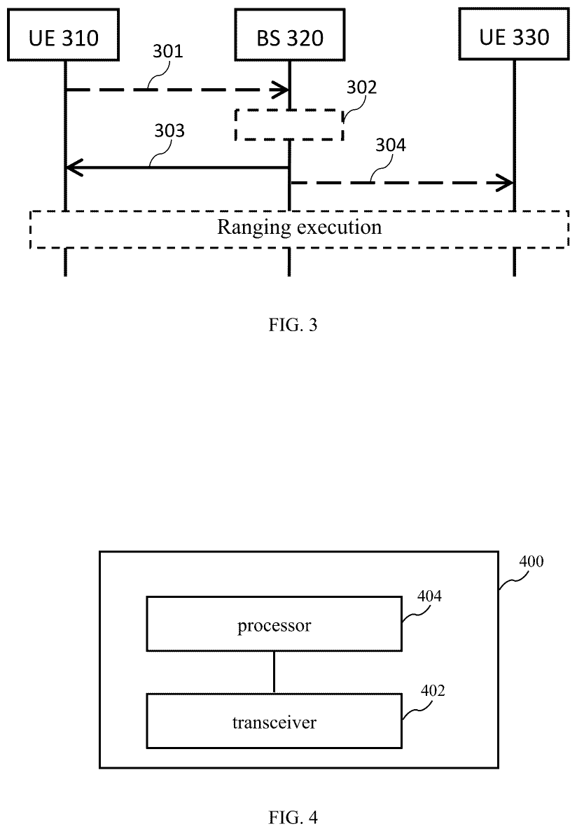

FIG. 3 illustrates an exemplary flowchart of transmitting ranging opportunity configuration information in accordance with some embodiments of the present application.

In embodiments of FIG. 3, operation 301 is optional which is marked as a dotted line in FIG. 3. In operation 301 as shown in FIG. 3, UE 310 transmits, to BS 320, a ranging opportunity request for a ranging window and/or a ranging gap associated with further UE(s) (e.g., UE 330). The ranging opportunity request may also be named as “a request for ranging opportunity” “a request for ranging time opportunity”, “a request for ranging period”, “a request for ranging time period”, or the like.

In the ranging opportunity request, UE 310 can request or report assistance information for ranging opportunity to BS 320. In some embodiments, the ranging opportunity request may include at least one of:
(1) An indication to request ranging window configuration and/or ranging gap configuration.
(2) Type of the requested ranging window, which may indicate whether UE 310 can execute transmission and/or reception in the requested ranging window for ranging measurement.
(3) Type of the requested ranging gap, which may indicate whether UE 310 can switch to/from its ranging transmitter and/or its ranging receiver (i.e., ranging transceiver) in the requested ranging gap for ranging measurement.
(4) Role of UE 310. The role may indicate whether UE 310 is an observer UE, a target UE, and/or an anchor UE when using the requested ranging window and/or the requested ranging gap.
(5) At least one ID of associated further UE(s) (e.g., UE 330) for ranging, which may indicate for which associated further UE(s) the requested ranging window or ranging gap can be used by UE 310; or an indication to indicate that the requested ranging window and/or the requested ranging gap can be used by UE 310 for all its associated further UE(s) (e.g., including UE 330).
(6) An indication to indicate whether the requested ranging gap is only dedicated for ranging measurement or is shared between the ranging measurement and other measurement(s). For example, other measurement(s) may be SMTC measurement, SFTD measurement, RSTD measurement, and/or IDC measurement.
(7) At least one kind of capability of UE 310, which is associated with the requested ranging window and/or the requested ranging gap. For example, a kind of capability of UE 310 is that UE 310 supports full duplex or multiple RF modules activation.
(8) Preferred length of the requested ranging window and/or the requested ranging gap
(9) Preferred repetition period of the requested ranging window and/or the requested ranging gap.
(10) Preferred start time or offset of the requested ranging window and/or the requested ranging gap.
(11) Preferred timing advance of the requested ranging window and/or the requested ranging gap.
(12) Preferred frequency band associated with the requested ranging window and/or the requested ranging gap.

In some embodiments, the ranging measurement could be a ranging reference signal reception/transmission at an observer/target UE. In some other embodiments, the ranging measurement could be a target-unaware ranging signal (e.g., laser or electronic pulse) transmission and reflection reception at an observer UE.

In some embodiments, UE 310 could transmit the ranging opportunity request to BS 320 via dedicated signaling, including RRC signaling (e.g., a RRC establish request message, a RRC establish complete message, or a RRC reconfiguration complete message) or a medium access control (MAC) control element (CE) in a CONNECTED mode. In some other embodiments, UE 310 could transmit the ranging opportunity request to an intermediate UE via dedicated sidelink signaling or a sidelink MAC CE.

Referring back to FIG. 3, in operation 302 which is optional as marked as a dotted block as shown in FIG. 3, to find associated further UE(s) (e.g., UE 330) whose ID(s) for ranging is included in the ranging opportunity request, BS 320 may discover associated further UE(s). In some embodiments, BS 320 could broadcast the received identity for ranging. In some other embodiments, BS 320 could search for the received ID(s) for ranging in a stored mapping table between ID(s) of UE(s) for ranging and ID(s) of UE(s) used in the network. For example, a UE's ID used in the network could be C-RNTI, 5G-GUTI, 5G-S-TMSI, or SUCI.

In operation 303 as shown in FIG. 3, BS 320 transmits, to UE 310, ranging opportunity configuration consisting of ranging window and/or ranging gap for one or more associated further UEs (e.g., UE 330).

In some embodiments, the ranging opportunity configuration could include configuration of at least one ranging time window during which UE 310 may execute ranging measurement with one or more associated further UEs (e.g., UE 330). Such configuration may include:
(1) Type of the ranging window that indicates whether UE 310 can execute transmission and/or reception in the ranging window for ranging measurement.
(2) Role of UE 310 that indicates whether UE 310 is an observer UE, a target UE, and/or an anchor UE when using the ranging window for ranging measurement.
(3) At least one ID of associated further UE(s) for ranging, which indicates for which associated further UE (e.g., UE 330) the ranging window can be used by UE 310 to execute ranging measurement; or an indication to indicate that the ranging window can be used by UE 310 for all its associated further UE(s) (e.g., including UE 330).
(4) Preconditions for application of the ranging window that indicates at least one kind of capability of UE 310 which are required or excluded to use the ranging window. For example, UE 310 supports full duplex or multiple RF modules activation.
(5) Ranging window length that indicates a time length of the ranging window.
(6) Ranging window repetition period that indicates a time cycle of appearance of the ranging window in time domain.
(7) Ranging window offset that indicates the time offset to the repetition period as the start of the ranging window.
(8) Ranging window timing advance that indicates the timing advance applied at UE 310 when using the ranging window.
(9) Ranging window frequency band that indicates the radio frequency associated with the ranging window.
(10) Reference cell indicator that indicates the cell whose system frame and/or subframe are used for calculating the ranging window.

In some other embodiments, the ranging opportunity configuration could include configuration of at least one ranging time gap during which UE 310 may switch to or switch from its ranging transceiver for executing the ranging measurement. Such ranging opportunity configuration may include:
(1) An indication to indicate whether the ranging gap is only dedicated for the ranging measurement or is shared between the ranging measurement and other measurement(s), e.g., SMTC, SFTD, RSTD, and/or IDC measurement.
(2) Type of the ranging gap that indicates whether UE 310 can switch to/from its ranging transmitter and/or ranging receiver (i.e., ranging transceiver) in the ranging gap for the ranging measurement.
(3) Role of UE 310 that indicates whether UE 310 is an observer UE, a target UE, and/or an anchor UE when using the ranging gap.
(4) At least one ID of associated further UE(s) for ranging that indicates for which associated further UE(s) the ranging gap can be used by UE 310 to switch to/from its ranging transceiver for ranging measurement execution; or an indication to indicate that the ranging gap can be used by UE 310 for all its associated further UE(s).
(5) Preconditions for application of the ranging gap that indicates at least one kind of capability of UE 310 required or excluded to use the ranging gap. For example, UE 310 supports full duplex or multiple RF modules activation.
(6) Ranging gap length that indicates the time length of the ranging gap. This element could be absent if the ranging gap is shared between the ranging measurement and other measurement(s).
(7) Ranging gap repetition period that indicates the time cycle of appearance of the ranging gap in time domain. This element could be absent if the ranging gap is shared between the ranging measurement and other measurement(s).
(8) Ranging gap offset that indicates the time offset to the repetition period as the start of the ranging gap. This element could be absent if the ranging gap is shared between the ranging measurement and other measurement(s).
(9) Ranging gap timing advance that indicates the timing advance applied at UE 310 when using the ranging gap. This element could be absent if the ranging gap is shared between the ranging measurement and other measurement(s).
(10) Ranging gap frequency band that indicates the radio frequency associated with the ranging gap.
(11) Reference cell indicator that indicates the cell whose system frame and/or subframe are used for calculating the ranging gap. This element could be absent if the ranging gap is shared between the ranging measurement and other measurement(s).

In some embodiments, the ranging opportunity configuration could be received by UE 310 from BS 320 via dedicated signaling, including RRC signaling (a RRC establish, release, suspend or reconfiguration message) or a MAC CE in CONNECTED mode, or via system information broadcasting in CONNECTED mode, IDLE mode, or INACTIVE mode. In some other embodiments, the ranging opportunity configuration could be received by UE 310 from an intermediate UE (not shown in FIG. 3) via dedicated sidelink signaling or sidelink MAC CE in CONNECTED mode, or via sidelink system information broadcasting in CONNECTED mode, IDLE mode, or INACTIVE mode.

In some embodiments, UE 310 releases the ranging opportunity configuration. For example, UE 310 could release or discard the ranging opportunity configuration when UE 310 handovers or reselects to another cell other than the configured cell.

Referring back to FIG. 3, in operation 304 which is optional as marked as a dotted block as shown in FIG. 3, BS 320 may transmit configuration to associated further UE (e.g., UE 330). For example, BS 320 could transmit, to UE 330, further ranging opportunity configuration that is aligned or paired with the ranging opportunity configuration transmitted to UE 310 in time and/or frequency domain. In some embodiments, ranging opportunity configurations transmitted to UE 310 and UE 330 have the same parameters in a length, a repetition period, start time and/or a frequency band, but have opposite parameters in a type of the ranging window, a type of the ranging gap, and/or a role of UE 310.

Details described in all other embodiments of the present application (for example, details regarding configuring a ranging opportunity/period for a UE in cellular networks) are applicable for the embodiments of FIG. 3. Moreover, details described in the embodiments of FIG. 3 are applicable for all the embodiments of FIGS. 1, 2, and 4.

FIG. 4 illustrates an exemplary block diagram of an apparatus according to some embodiments of the present application. As shown in FIG. 4, the apparatus 400 may include at least one processor 404 and at least one transceiver 402 coupled to the processor 404. The apparatus 400 may be a UE (e.g., UE 310 as shown and illustrated in FIG. 3) or a network node (e.g., BS 320 as shown and illustrated in FIG. 3).

Although in this figure, elements such as the at least one transceiver 402 and processor 404 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

According to some embodiments of the present application, the apparatus 400 may be a network node (e.g., BS 320 as shown and illustrated in FIG. 3) comprising a processor and a wireless transceiver coupled to the processor. The transceiver 402 in the network node may be configured to transmit, to a UE (e.g., UE 310 as shown and illustrated in FIG. 3), configuration information regarding a time period related to a ranging measurement operation between the UE and further UE(s) (e.g., UE 330 as shown and illustrated in FIG. 3). The time period includes a ranging time window and/or a ranging time gap. The ranging measurement operation is executed by the UE to the further UE(s) during the ranging time window. A RF switch procedure for the ranging measurement operation is executed by the UE during the ranging time gap.

According to some other embodiments of the present application, the apparatus 400 may be a UE (e.g., UE 310 as shown and illustrated in FIG. 3) comprising a processor and a wireless transceiver coupled to the processor. The transceiver 402 in the UE may be configured to receive, from a network node (e.g., BS 320 as shown and illustrated in FIG. 3), configuration information regarding a time period related to a ranging measurement operation between the UE and further UE(s). The time period includes a ranging time window and/or a ranging time gap. The ranging measurement operation is executed by the UE to the further UE(s) during the ranging time window. A RF switch procedure for the ranging measurement operation is executed by the UE during the ranging time gap. In following text, the UE is named as “the 1st UE”, and the further UE(s) are named as “the 2nd UE(s)”.

In some embodiments, the ranging measurement operation includes at least one of:
(1) A ranging reference signal (RS) transmission at an observer UE.
(2) A ranging RS transmission at a target UE.
(3) A ranging RS reception at the observer UE.
(4) A ranging RS reception at the target UE.
(5) A target-unaware ranging signal transmission at the observer UE.
(6) A target-unaware ranging signal reflection reception at the observer UE.
(7) A positioning reference signal (PRS) transmission via a sidelink. The sidelink is between two UEs of the observer UE, the target UE, and an anchor UE. The PRS transmission is performed via the observer UE, the target UE, and/or the anchor UE. For example, the PRS transmission may be:
   a) a PRS transmission at the observer UE or the anchor UE for sidelink positioning (absolute or relative positioning between UEs); or
   b) a PRS transmission at the target UE for sidelink positioning (absolute or relative positioning between UEs).
(8) A PRS reception via the sidelink. The PRS reception is performed via the observer UE, the target UE, and/or the anchor UE. For example, the PRS reception may be:
   a) a PRS reception at the observer UE or the anchor UE for sidelink positioning (absolute or relative positioning between UEs); or
   b) a PRS reception at the target UE for sidelink positioning (absolute or relative positioning between UEs).

In some embodiments, the configuration information may be transmitted from the network node to the 1st UE via a RRC signaling message, a MAC CE, and/or a system information broadcast message. For example, the RRC signaling message may be a RRC establish message, a RRC release message, a RRC suspend message, and/or a RRC reconfiguration message.

In some other embodiments, the 1st UE may receive the configuration information from an intermediate UE via a dedicated sidelink signaling message, a sidelink MAC CE, and/or a sidelink system information broadcast message.

In some embodiments, the configuration information received by the 1st UE includes: configuration information regarding the ranging time window; and/or configuration information regarding the ranging time gap.

In an embodiment, the configuration information regarding the ranging time window includes at least one of:
(1) An indication indicating the 1st UE can execute which measurement kind of the ranging measurement operation in the ranging time window.
(2) A role of the 1st UE when using the ranging time window. The role of the 1st UE is an observer UE, a target UE, and/or an anchor UE.
(3) An ID of a UE associated with the ranging measurement operation within the 2nd UE(s).
(4) An indication indicating whether the ranging time window can be used by the 1st UE for all the 2nd UE(s).
(5) Precondition(s) of the ranging time window applied to the 1st UE.
(6) A time length of the ranging time window.
(7) A repetition period (e.g., a time cycle) in time domain of the ranging time window.
(8) A start time offset to the repetition period in the time domain of the ranging time window.
(9) Timing advance applied at the 1t UE when using the ranging time window.
(10) A frequency band associated with the ranging time window.
(11) A reference cell indicator associated with the ranging time window.

In an embodiment, the configuration information regarding the ranging time gap includes at least one of:
(1) An indication indicating whether the RF switch procedure related to the ranging time gap is only dedicated for the ranging measurement operation or is shared between the ranging measurement operation and a further measurement operation. The further measurement operation may be a SMTC measurement operation, a SFTD measurement operation, a RSTD measurement operation, and/or an IDC measurement operation.
(2) An indication indicating the 1st UE can execute which switch kind of the RF switch procedure in the ranging time gap. A switch kind of the RF switch procedure may include: the RF switch procedure for transmission, and/or the RF switch procedure for reception.
(3) A role of the 1st UE when using the ranging time gap. The role of the 1st UE is an observer UE, a target UE, and/or an anchor UE.
(4) An ID of a UE associated with the RF switch procedure within the 2nd UE(s).
(5) Precondition(s) of the ranging time gap applied to the 1st UE.
(6) A time length of the ranging time gap.
(7) A repetition period in time domain of the ranging time gap.
(8) A start time offset to the repetition period in the time domain of the ranging time gap.
(9) Timing advance applied at the 1st UE when using the ranging time gap.
(10) A frequency band associated with the ranging time gap.
(11) A reference cell indicator associated with the ranging time gap.

In some embodiments, the transceiver 402 in the network node may be configured to receive a request for the time period via the wireless transceiver from the 1st UE. In some embodiments, the request is received via a RRC signaling message, a MAC CE, and/or a system information broadcast message. For example, the RRC signaling message may be a RRC establish request message, a RRC establish complete message, and/or a RRC reconfiguration complete message. In some embodiments, the request includes:
(1) An indication for requesting the configuration information transmitted to the 1st UE.
(2) An indication indicating whether the 1st UE can execute the ranging measurement operation in the ranging time window.
(3) An indication indicating whether the 1st UE can execute the RF switch procedure in the ranging time gap.
(4) A role of the 1st UE when using the ranging time window.
(5) The role of the 1st UE when using the ranging time gap. The role of the 1st UE is an observer UE, a target UE, and/or an anchor UE.
(6) An ID of another UE (named as “the 3rd UE” in following text) associated with the ranging measurement operation within the 2nd UE(s).
(7) An ID of yet another UE (named as “the 4th UE” in following text) associated with the RF switch procedure within the 2nd UE(s). In some embodiments, if the request includes the 3rd UE's ID and/or the 4th UE's ID, the transceiver 402 in the network node may be further configured: to broadcast the 3rd UE's ID and/or the 4th UE's ID; or to search the 3rd UE's ID and/or the 4th UE's ID in a mapping table between ID(s) of the 2nd UE(s) and ID(s) of additional UE(s) used in the network node. For example, ID(s) of these additional UE(s) may include: a cell radio network temporary identifier (C-RNTI); a 5G globally unique temporary identifier (5G-GUTI); 5G short temporary mobile subscription identifier (5G-S-TMSI); and/or subscription concealed identifier (SUCI).
(8) An indication indicating whether the ranging time window can be used by the 1st UE for all the 2nd UE(s).
(9) An indication indicating whether the ranging time gap can be used by the 1st UE for all the 2nd UE(s).
(10) An indication indicating whether the ranging time gap is only dedicated for the ranging measurement operation or is shared between the ranging measurement operation and a further measurement operation. The further measurement operation may be a SMTC measurement operation, a SFTD measurement operation, a RSTD measurement operation, and/or an IDC measurement operation.
(11) Capability information of the 1st UE associated with the ranging time window.
(12) Capability information of the 1st UE associated with the ranging time gap.
(13) A preferred time length of the ranging time window.
(14) A preferred time length of the ranging time gap.
(15) A preferred repetition period in time domain of the ranging time window.
(16) a preferred repetition period in time domain of the ranging time gap.
(17) Preferred start time of the ranging time window.
(18) Preferred start time of the ranging time gap.
(19) Preferred a start time offset to a repetition period in time domain of the ranging time window.
(20) Preferred a start time offset to a repetition period in time domain of the ranging time gap.
(21) Preferred timing advance of the ranging time window.
(22) Preferred timing advance of the ranging time gap.
(23) A preferred frequency band associated with the ranging time window.
(24) A preferred frequency band associated with the ranging time gap.

In some embodiments, the transceiver 402 in the network node is further configured to transmit, to the 2nd UE(s), further configuration information regarding the time period. Parameter(s) of the further configuration information may be aligned with parameters of the configuration information transmitted to the 1st UE.

In an embodiment, the configuration information transmitted to the 1st UE and the further configuration information transmitted to the 2nd UE(s) have identical parameters in:
(1) a length of the ranging time window;
(2) a length of the ranging time gap;
(3) a repetition period in time domain of the ranging time window;
(4) a repetition period in the time domain of the ranging time gap;
(5) start time of the ranging time window;
(6) start time of the ranging time gap;
(7) a frequency band of the ranging time window; and
(8) a frequency band of the ranging time gap; and

In an embodiment, the configuration information transmitted to the 1st UE and the further configuration information transmitted to the 2nd UE(s) have opposite parameters in at least one of:
(1) an indication indicating whether the 1st UE can execute the ranging measurement operation in the ranging time window;
(2) an indication indicating whether the 1st UE can execute the RF switch procedure in the ranging time gap; and
(3) a role of the 1st UE. The role of the 1st UE may be an observer UE, a target UE, and/or an anchor UE.

In some embodiments, the processor 404 in the 1st UE is further configured: to reselect or handover to a further cell which is different from a cell of the 1st UE configured by the received configuration information, and to release the received configuration information.

In some embodiments of the present application, the apparatus 400 in FIG. 4 may further include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 404 interacting with transceiver 402, so as to perform operations of the methods, e.g., as described in view of FIG. 2 or FIG. 3.

Some embodiments provide a method performed by a network node (e.g., BS 320 as shown and illustrated in FIG. 3). The method comprises: transmitting, to a UE (e.g., UE 310 as shown and illustrated in FIG. 3), configuration information regarding a time period related to a ranging measurement operation between the UE and further UE(s). The time period includes a ranging time window and/or a ranging time gap. The ranging measurement operation is executed by the UE to the further UE(s) during the ranging time window. A RF switch procedure for the ranging measurement operation is executed by the UE during the ranging time gap.

Some embodiments provide a method performed by a UE (e.g., UE 310 as shown and illustrated in FIG. 3). The method comprises: receiving, from a network node (e.g., BS 320 as shown and illustrated in FIG. 3), configuration information regarding a time period related to a ranging measurement operation between the UE and further UE(s). The time period includes a ranging time window and/or a ranging time gap. The ranging measurement operation is executed by the UE to the further UE(s) during the ranging time window. A RF switch procedure for the ranging measurement operation is executed by the UE during the ranging time gap.

Details described in all other embodiments of the present application (for example, details regarding configuring a ranging opportunity/period for a UE in cellular networks) are applicable for the embodiments of FIG. 4. Moreover, details described in the embodiments of FIG. 4 are applicable for all the embodiments of FIGS. 1-3.

The following texts describe specific Embodiments 1-4 of the method as shown and illustrated in FIGS. 2-4. According to Embodiments 1-4, a UE, a BS, and/or a further UE perform the following operations. The UE may be Observer UE, UE1, or UE 310 as shown and illustrated in any of FIGS. 1-3. The BS may be BS0 or BS 320 as illustrated and shown in any of FIGS. 1 and 3. The further UE may be Target UE, UE2, or UE 330 as shown and illustrated in any of FIGS. 1-3.

### Embodiment 1

In Embodiment 1, a 1st UE sends a request or a report for ranging opportunity to a BS. The request or the report includes at least one of following information items:
(1) An indication to request ranging window configuration and/or ranging gap configuration. For example, a ranging opportunity consisting of ranging window configuration and/or ranging gap configuration is expected from the BS after the BS successful receives the request or the report.
(2) Type of the requested ranging window, which may be: a ranging window only for transmission at the 1st UE, a ranging window only for reception at the 1st UE, or a ranging window for transmission and/or reception at the 1st UE.
(3) Type of the ranging gap, which may be: a ranging gap only for ranging transmitter switch on/off at the 1st UE, a ranging gap only for ranging receiver switch on/off at the 1st UE, or a ranging gap for ranging transceiver switch on/off at the 1st UE.
(4) Role indication of the 1st UE. For example, the 1st UE is an observer UE, a target UE, and/or an anchor UE when using the requested ranging window or ranging gap.
(5) At least one ID of associated 2nd UE(s) for ranging that indicates for which associated 2nd UE(s) the requested ranging window or ranging gap can be used by the 1st UE; or an indication to indicate that the requested ranging window or ranging gap can be used by the 1st UE for all its associated 2nd UE(s).
(6) An indication to indicate whether the requested ranging gap is only dedicated for ranging measurement or is shared between ranging measurement and other measurement(s), e.g., SMTC, SFTD, RSTD, and/or IDC measurement.
(7) At least one kind of capability of the 1st UE associated with the requested ranging window or ranging gap, e.g., supporting full duplex or multiple RF modules activation.
(8) Preferred length of the requested ranging window or ranging gap, e.g., in ms or subframe unit.
(9) Preferred repetition period of the requested ranging window or ranging gap, e.g., in ms or subframe unit.
(10) Preferred start time or offset of the requested ranging window or ranging gap, e.g., in ms or subframe unit.
(11) Preferred timing advance of the requested ranging window or ranging gap, e.g., in ms or subframe unit.
(12) Preferred frequency band associated with the requested ranging window or ranging gap, e.g., in Hz unit or band number.

After receiving the request or the report for ranging opportunity from the 1st UE, the BS configures ranging window and/or ranging gap to the 1st UE accordingly.

### Embodiment 2

In Embodiment 2, a 1st UE receives ranging window configuration for at least one associated 2nd UE(s) from a BS. The ranging window configuration includes at least one of following information items:
(1) Type of the ranging window, which may be:
   a) A ranging window only for transmission at the 1st UE. The ranging window can be used by the 1st UE to transmit ranging signal as an observer UE, or to transmit ranging reference signal as a target UE.
   b) A ranging window only for reception at the 1st UE. The ranging window can be used by the 1st UE to receive or reflect ranging signal as a target UE, or to receive ranging reference signal as an observer UE.
   c) A ranging window for transmission and/or reception at the 1st UE. The ranging window can be used by the 1st UE to transmit ranging signal or to receive ranging reference signal as an observer UE, or to transmit ranging reference signal or to receive or reflect ranging signal as a target UE.
(2) Role indication of the 1st UE. For example, the 1st UE may be an observer UE, a target UE, and/or an anchor UE when using the requested ranging window.
(3) At least one ID of associated 2nd UE(s) for ranging, which may indicate:
   a) The configured ranging window can be used by the 1st UE to execute ranging measurement for the associated 2nd UE(s)
   b) When absent or null, as an indication to indicate that the ranging window can be used by the 1st UE to execute ranging measurement for all its associated 2nd UE(s).
(4) Preconditions for application of the ranging window that indicates at least one kind of capability of the 1st UE required or excluded to use the ranging window, including:
   a) If the 1st UE supports full duplex communication, it may use the configured ranging window for transmission/reception while receiving from or transmitting to the BS.
   b) If the 1st UE does not support full duplex communication, it may not use the configured ranging window for transmission/reception while receiving from or transmitting to the BS.
   c) If the 1st UE supports multiple RF modules activation, it may use the configured ranging window for transmission/reception while transmitting to or receiving from the BS.
   d) If the 1st UE does not support multiple RF modules activation, it may not use the configured ranging window for transmission/reception while transmitting to or receiving from the BS.
(5) Ranging window length that indicates the time length of the ranging window, e.g., in ms or subframe unit.
(6) Ranging window repetition period that indicates the time cycle of appearance of the ranging window, e.g., in ms or subframe unit.
(7) Ranging window offset that indicates the time offset to the repetition period as the start of the ranging window, e.g., in ms or subframe unit.
(8) Ranging window timing advance that indicates the timing advance applied at the 1st UE when using the ranging window, e.g., in ms or subframe unit.
(9) Ranging window frequency band that indicates the radio frequency associated with the ranging window, e.g., in Hz unit or band number.
(10) Reference cell indicator that indicates the cell whose system frame and/or subframe are used for calculating the ranging window.

An example to implement dedicated ranging window configuration in 3GPP specifications may be as follows.

RangWindow information element (IE)

--ASN1START
--TAG-RangWindow-START

| | |
|---|---|
| RangWindow ::= | SEQUENCE { |

| | |
|---|---|
| rwindowType ::= | CHOICE { |

| | |
|---|---|
| Tx | BOOLEAN, |

| | |
|---|---|
| Rx | BOOLEAN, |
| TxRx | BOOLEAN, |

...

}

| | |
|---|---|
| rwindowCond ::= | CHOICE { |

| | |
|---|---|
| FullDuplex | BOOLEAN, |

| | |
|---|---|
| MultiRF | BOOLEAN, |

...

| | |
|---|---|
| } | OPTIONAL, -- Need R |

| | |
|---|---|
| rangUElist | SEQUENCE (SIZE (1..maxRangUE)) OF rangUE-Identity |

OPTIONAL, -- Need S

| | |
|---|---|
| rangUE-Identity | INTEGER (1..maxRangUE) |

| | |
|---|---|
| periodicityAndOffsetRang | CHOICE { |

| | |
|---|---|
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

| }, | |
|---|---|
| durationRang | ENUMERATED { sf1, sf2, sf3, sf4, sf5 } |
| pci-List | SEQUENCE (SIZE (1..maxNrofPCIsPerSMTC)) |

| | |
|---|---|
| OF PhysCellId | OPTIONAL, -- Need M |

| | |
|---|---|
| periodicityRang | ENUMERATED {sf5, sf10, sf20, sf40, sf80, |

spare3, spare2, spare1}
}

### Embodiment 3

In Embodiment 3, a 1st UE receives a ranging gap configuration for at least one associated 2nd UE from a BS. The ranging gap configuration includes at least one of following information items:
(1) An indication to indicate whether the ranging gap is only dedicated for ranging measurement or is shared between ranging measurement and other measurement(s), e.g., SMTC, SFTD, RSTD, and/or IDC measurement. If the ranging gap is a shared gap, the 1st UE can decide the order of performing measurements depending on its length and the time required for measurements.
(2) Type of the ranging gap, which may be:
   a) A ranging gap only for the transmitter at the 1st UE. The ranging gap can be used by the 1st UE to switch on/off its ranging transmitter.
   b) A ranging gap only for the receiver at the 1st UE. The ranging gap can be used by the 1st UE to switch on/off its ranging receiver.
   c) A ranging gap for the transceiver at the 1st UE. The ranging gap can be used by the 1st UE to switch on/off its ranging transceiver.
(3) Role indication of the 1st UE. For example, the 1st UE is an observer UE, a target UE, and/or an anchor UE when using the requested ranging gap.
(4) At least one ID of associated 2nd UE(s) for ranging, which may also indicate:
   a) The configured ranging gap can be used by the 1st UE to switch on/off its transceiver for ranging measurement for the associated 2nd UE(s).
   b) When absent or null, as an indication to indicate that the ranging gap can be used by the 1st UE to switch on/off its transceiver for ranging measurement for all its associated UEs.
(5) Preconditions for application of the ranging window that indicates at least one kind of capability of the 1st UE required or excluded to use the ranging window, including:
   a) If the 1st UE supports full duplex communication and multiple RF modules activation, it may ignore the configured ranging gap.
   b) If the 1st UE does not support full duplex communication or multiple RF modules activation, it may use the configured ranging gap.
   c) If the 1st UE supports full duplex communication, it may use the configured ranging window for transmission/reception while receiving from/transmitting to the BS.
   d) If the 1st UE does not support full duplex communication, it may not use the configured ranging window for transmission/reception while receiving from or transmitting to the BS.
   e) If the 1st UE supports multiple RF modules activation, it may use the configured ranging window for transmission/reception while transmitting to or receiving from the BS.
   f) If the 1st UE does not support multiple RF modules activation, it may not use the configured ranging window for transmission/reception while transmitting to or receiving from the BS.
(6) Ranging gap length that indicates the time length of the ranging gap, e.g., in ms or subframe unit. This element could be absent if the ranging gap is shared between the ranging measurement and other measurement(s).
(7) Ranging gap repetition period that indicates the time cycle of ranging gap appearance, e.g., in ms or subframe unit. This element could be absent if the ranging gap is shared between the ranging measurement and other measurement(s).
(8) Ranging gap offset that indicates the time offset to the repetition period as the start of the ranging gap, e.g., in ms or subframe unit. This element could be absent if the ranging gap is shared between the ranging measurement and other measurement(s).
(9) Ranging gap timing advance that indicates the timing advance applied at the 1st UE when using the ranging gap, e.g., in ms or subframe unit. This element could be absent if the ranging gap is shared between the ranging measurement and other measurement(s).
(10) Ranging gap frequency band that indicates the radio frequency associated with the ranging gap, e.g., in Hz unit or band number. This element could be absent if the ranging gap is shared between the ranging measurement and other measurement(s).
(11) Reference cell indicator that indicates the cell whose system frame and/or subframe are used for calculating the ranging gap. This element could be absent if the ranging gap is shared between the ranging measurement and other measurement(s).

An example to implement dedicated ranging gap configuration in 3GPP specifications may be as follows. The IE RangGapConfig specifies the ranging gap configuration and controls setup/release of ranging gaps.

RangGapConfig information element (IE)

--ASN1START

| | |
|---|---|
| RangGapConfig ::= | CHOICE { |

| | |
|---|---|
| release | NULL, |
| setup | SEQUENCE { |

| | |
|---|---|
| rgapType ::= | CHOICE { |

| | |
|---|---|
| Tx | BOOLEAN, |

| | |
|---|---|
| Rx | BOOLEAN, |
| TxRx | BOOLEAN, |

...

| } | |
|---|---|
| rgapCond ::= | CHOICE { |

| | |
|---|---|
| FullDuplex | BOOLEAN, |

| | |
|---|---|
| MultRF | BOOLEAN, |

...

| | |
|---|---|
| } | OPTIONAL, -- Need R |

| | |
|---|---|
| rangUElist | SEQUENCE (SIZE (1..maxRangUE)) OF |

rangUE-Identity

OPTIONAL, -- Need S

| | |
|---|---|
| rangUE-Identity | INTEGER (1..maxRangUE) |

| | |
|---|---|
| rgapOffset | CHOICE { |

| | |
|---|---|
| rgp0 | INTEGER (0..x1), |
| rgp1 | INTEGER (0..x2), |

...,
}

}

}

--ASN1STOP

An example to implement shared ranging gap configuration in 3GPP specifications may be as follows. The IE MeasGapConfig specifies the measurement gap configuration and controls setup/release of measurement gaps.

MeasGapConfig information element (IE)

-- ASN1START

| | |
|---|---|
| MeasGapConfig :: = | CHOICE { |

| | |
|---|---|
| release | NULL, |
| setup | SEQUENCE { |

| | |
|---|---|
| gapOffset | CHOICE { |

| | |
|---|---|
| gp0 | INTEGER (0..39), |
| gp1 | INTEGER (0..79), |
| ..., | |
| gp2-r14 | INTEGER (0..39), |
| gp3-r14 | INTEGER (0..79), |
| gp-ncsg0-r14 | INTEGER (0..39), |
| gp-ncsg1-r14 | INTEGER (0..79), |
| gp-ncsg2-r14 | INTEGER (0..39), |
| gp-ncsg3-r14 | INTEGER (0..79), |
| gp-non Uniform1-r14 | INTEGER (0..1279), |
| gp-nonUniform2-r14 | INTEGER (0..2559), |
| gp-non Uniform3-r14 | INTEGER (0..5119), |
| gp-nonUniform4-r14 | INTEGER (0..10239), |
| gp4-r15 | INTEGER (0..19), |
| gp5-r15 | INTEGER (0..159), |
| gp6-r15 | INTEGER (0..19), |
| gp7-r15 | INTEGER (0..39), |
| gp8-r15 | INTEGER (0..79), |
| gp9-r15 | INTEGER (0..159), |
| gp10-r15 | INTEGER (0..19), |
| gp11-r15 | INTEGER (0..159) |

}

}

}

| | |
|---|---|
| MeasGapConfig-r18 ::= | CHOICE { |

| | |
|---|---|
| release | NULL, |
| setup | SEQUENCE { |

| | | |
|---|---|---|
| rgapShared | BOOLEAN, | OPTIONAL, -- NEED R |

| | |
|---|---|
| rgapType ::= | CHOICE { |

| | |
|---|---|
| Tx | BOOLEAN, |

| | |
|---|---|
| Rx | BOOLEAN, |
| TxRx | BOOLEAN, |

...

| | |
|---|---|
| } | OPTIONAL, -- NEED R |

| | |
|---|---|
| rgapCond ::= | CHOICE { |

| | |
|---|---|
| FullDuplex | BOOLEAN, |

| | |
|---|---|
| MultiRF | BOOLEAN, |

| | |
|---|---|
| ... | OPTIONAL, -- NEED R |

| } | |
|---|---|
| rangUElist | SEQUENCE (SIZE (1..maxRangUE)) OF |

| rangUE-Identity | |
|---|---|
| | OPTIONAL, -- Need S |

| | |
|---|---|
| rangUE-Identity | INTEGER (1..maxRangUE) |

| | |
|---|---|
| gapOffset | CHOICE { |

| rgp0 | INTEGER (0..39), |
|---|---|
| rgp1 | INTEGER (0..79), |
| ..., | |
| gp2-r14 | INTEGER (0..39), |
| gp3-r14 | INTEGER (0..79), |
| gp-ncsg0-r14 | INTEGER (0..39), |
| gp-ncsgl-r14 | INTEGER (0..79), |
| gp-ncsg2-r14 | INTEGER (0..39), |
| gp-ncsg3-r14 | INTEGER (0..79), |
| gp-non Uniform1-r14 | INTEGER (0..1279), |
| gp-non Uniform2-r14 | INTEGER (0..2559), |
| gp-non Uniform3-r14 | INTEGER (0..5119), |
| gp-nonUniform4-r14 | INTEGER (0..10239), |
| gp4-r15 | INTEGER (0..19), |
| gp5-r15 | INTEGER (0..159), |
| gp6-r15 | INTEGER (0..19), |
| gp7-r15 | INTEGER (0..39), |
| gp8-r15 | INTEGER (0..79), |
| gp9-r15 | INTEGER (0..159), |
| gp10-r15 | INTEGER (0..19), |
| gp11-r15 | INTEGER (0..159) |

}

}

}
--ASN1STOP

### Embodiment 4

In Embodiment 4, a BS receives a ranging opportunity request for a ranging window and/or a ranging gap associated with one or more associated further UE(s) from a UE. To find associated further UE(s) whose ID(s) for ranging is included in the UE's request/report for ranging opportunity configuration, the BS could broadcast the received ID(s) for ranging, could search for the received ID(s) for ranging in a stored mapping table between UE's ID(s) for ranging and UE's ID(s) used in the network. The UE's ID(s) used in the network could be C-RNTI, 5G-GUTI, 5G-S-TMSI, or SUCI.

In Embodiment 4, the BS transmits ranging opportunity configuration for one or more associated further UE(s) to the UE. The duration of the ranging gap at least covers the duration of the ranging window. The ranging window configuration includes at least one information item as described in above Embodiment 2. The ranging gap configuration includes at least one information item as described in above Embodiment 3.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A base station for wireless communication, comprising:
at least one memory; and
at least one processor coupled with the at least one memory and configured to cause the base station to:
transmit, to a first user equipment (UE), first configuration information regarding a time period related to a ranging measurement operation between the first UE and one or more second UEs, wherein the time period includes at least one of a ranging time window and a ranging time gap,
wherein the ranging measurement operation is executed by the first UE to the one or more second UEs during the ranging time window, and
wherein a radio frequency (RF) switch procedure for the ranging measurement operation is executed by the first UE during the ranging time gap.

2. The base station of claim 1, wherein the first configuration information includes at least one of:
configuration information regarding the ranging time window; and
configuration information regarding the ranging time gap.

3. (canceled)

4. (canceled)

5. The base station of claim 1, wherein the at least one processor is further configured to cause the base station to receive a request for the time period from the first UE.

6. The base station of claim 1, wherein the ranging measurement operation includes at least one of:
a ranging reference signal (RS) transmission at an observer UE;
a ranging RS transmission at a target UE;
a ranging RS reception at the observer UE;
a ranging RS reception at the target UE;
a target-unaware ranging signal transmission at the observer UE;
a target-unaware ranging signal reflection reception at the observer UE;
a positioning reference signal (PRS) transmission via a sidelink, wherein the sidelink is between two of the observer UE, the target UE, and an anchor UE, and wherein the PRS transmission is performed via at least one of the observer UE, the target UE, and the anchor UE; and
a PRS reception via the sidelink, wherein the PRS reception is performed via the at least one of the observer UE, the target UE, and the anchor UE.

7. A first user equipment (UE) for wireless communication, comprising:
at least one memory; and
at least one processor coupled with the at least one memory and configured to cause the first UE to:
receive, from a network node, first configuration information regarding a time period related to a ranging measurement operation between the first UE and one or more second UEs, wherein the time period includes at least one of a ranging time window and a ranging time gap;
execute the ranging measurement operation to the one or more second UEs during the ranging time window; and
execute a radio frequency (RF) switch procedure for the ranging measurement operation during the ranging time gap.

8. The first UE of claim 7, wherein the first configuration information includes at least one of:
configuration information regarding the ranging time window; and
configuration information regarding the ranging time gap.

9. The first UE of claim 8, wherein the configuration information regarding the ranging time window includes at least one of:
an indication indicating the first UE can execute which measurement kind of the ranging measurement operation in the ranging time window;
a role of the first UE when using the ranging time window;
an identifier (ID) of a UE associated with the ranging measurement operation within the one or more second UEs;
an indication indicating whether the ranging time window can be used by the first UE for all of the one or more second UEs;
one or more preconditions of the ranging time window applied to the first UE;
a time length of the ranging time window;
a repetition period in a time domain of the ranging time window;
a start time offset to the repetition period in the time domain of the ranging time window;
timing advance applied at the first UE when using the ranging time window;
a frequency band associated with the ranging time window; and
a reference cell indicator associated with the ranging time window.

10. The first UE of claim 8, wherein the configuration information regarding the ranging time gap includes at least one of:
an indication indicating whether the RF switch procedure related to the ranging time gap is only dedicated for the ranging measurement operation or is shared between the ranging measurement operation and a further measurement operation;
an indication indicating the first UE can execute which switch kind of the RF switch procedure in the ranging time gap, wherein a switch kind of the RF switch procedure includes at least one of: the RF switch procedure for transmission, and the RF switch procedure for reception;
a role of the first UE when using the ranging time gap;
an identifier (ID) of a UE associated with the RF switch procedure within the one or more second UEs;
one or more preconditions of the ranging time gap applied to the first UE;
a time length of the ranging time gap;
a repetition period in a time domain of the ranging time gap;
a start time offset to the repetition period in the time domain of the ranging time gap;
timing advance applied at the first UE when using the ranging time gap;
a frequency band associated with the ranging time gap; and
a reference cell indicator associated with the ranging time gap.

11. The first UE of claim 8, wherein the at least one processor is further configured to cause the first UE to transmit a request for the time period to the network node or an intermediate UE.

12. The first UE of claim 11, wherein the first configuration information or the request is included in at least one of:
a radio resource control (RRC) signaling message;
a medium access control (MAC) control element (CE);
a system information broadcast message;
a dedicated sidelink signaling message;
a sidelink MAC CE; and
a sidelink system information broadcast message.

13. The first UE of claim 11, wherein the request includes at least one of:
an indication for requesting the first configuration information;
an indication indicating whether the first UE can execute the ranging measurement operation in the ranging time window;
an indication indicating whether the first UE can execute the RF switch procedure in the ranging time gap;
a role of the first UE when using the ranging time window;
the role of the first UE when using the ranging time gap;
an identifier (ID) of a third UE associated with the ranging measurement operation within the one or more second UEs;
an ID of a fourth UE associated with the RF switch procedure within the one or more second UEs;
an indication indicating whether the ranging time window can be used by the first UE for all of the one or more second UEs;
an indication indicating whether the ranging time gap can be used by the first UE for all of the one or more second UEs;
an indication indicating whether the ranging time gap is only dedicated for the ranging measurement operation or is shared between the ranging measurement operation and a further measurement operation;
capability information of the first UE associated with the ranging time window;
capability information of the first UE associated with the ranging time gap;
a time length of the ranging time window;
a time length of the ranging time gap;
a repetition period in a time domain of the ranging time window;
a repetition period in the time domain of the ranging time gap;
start time of the ranging time window;
start time of the ranging time gap;
start time offset to a repetition period in the time domain of the ranging time window;
start time offset to a repetition period in the time domain of the ranging time gap;
timing advance of the ranging time window;
timing advance of the ranging time gap;
a frequency band associated with the ranging time window; and
a frequency band associated with the ranging time gap.

14. The first UE of claim 7, wherein the ranging measurement operation includes at least one of:
a ranging reference signal (RS) transmission at an observer UE;
a ranging RS transmission at a target UE;
a ranging RS reception at the observer UE;
a ranging RS reception at the target UE;
a target-unaware ranging signal transmission at the observer UE;
a target-unaware ranging signal reflection reception at the observer UE;
a positioning reference signal transmission via a sidelink between at least two of the observer UE, the target UE, and an anchor UE; and
a positioning reference signal reception via the sidelink between the at least two of the observer UE, the target UE, and the anchor UE.

15. The first UE of claim 7, wherein the at least one processor is further configured cause the first UE to:
reselect or handover to a second cell different from a first cell of the first UE, wherein the first cell is configured by the first configuration information; and
release the first configuration information.

16. A processor for wireless communication, comprising:
at least one controller coupled with at least one memory and configured to cause the processor to:
receive, from a network node, first configuration information regarding a time period related to a ranging measurement operation between first user equipment (UE) that includes the processor and one or more second UEs, wherein the time period includes at least one of a ranging time window and a ranging time gap;
execute the ranging measurement operation to the one or more second UEs during the ranging time window; and
execute a radio frequency (RF) switch procedure for the ranging measurement operation during the ranging time gap.

17. The processor of claim 16, wherein the first configuration information includes at least one of:
configuration information regarding the ranging time window; and
configuration information regarding the ranging time gap.

18. The processor of claim 17, wherein the at least one controller is further configured to cause the processor to transmit a request for the time period to the network node or an intermediate UE.

19. The processor of claim 16, wherein the first configuration information is included in at least one of:
a radio resource control (RRC) signaling message;
a medium access control (MAC) control element (CE);
a system information broadcast message;
a dedicated sidelink signaling message;
a sidelink MAC CE; and
a sidelink system information broadcast message.

20. The processor of claim 16, wherein the ranging measurement operation includes at least one of:
a ranging reference signal (RS) transmission at an observer UE;
a ranging RS transmission at a target UE;
a ranging RS reception at the observer UE;
a ranging RS reception at the target UE;
a target-unaware ranging signal transmission at the observer UE;
a target-unaware ranging signal reflection reception at the observer UE;
a positioning reference signal transmission via a sidelink between at least two of the observer UE, the target UE, and an anchor UE; and
a positioning reference signal reception via the sidelink between the at least two of the observer UE, the target UE, and the anchor UE.

21. The processor of claim 16, wherein the at least one controller is further configured cause the processor to:
reselect or handover to a second cell different from a first cell of the first UE, wherein the first cell is configured by the first configuration information; and
release the first configuration information.

22. A method performed by a user equipment (UE), the method comprising:
receiving, from a network node, first configuration information regarding a time period related to a ranging measurement operation between the first UE and one or more second UEs, wherein the time period includes at least one of a ranging time window and a ranging time gap;
executing the ranging measurement operation to the one or more second UEs during the ranging time window; and
executing a radio frequency (RF) switch procedure for the ranging measurement operation during the ranging time gap.
